(19) United States
(12) Patent Application Publication
(10) Pub. No.: US 2014/0097303 A1
(43) Pub. Date: Apr. 10, 2014

(54) Medical Fluid Line Alignment Devices and Related Systems and Methods

(71) Applicant: FRESENIUS MEDICAL CARE HOLDINGS, INC., Waltham, MA (US)

(72) Inventor: Jeffrey Lake, Eugene, OR (US)

(73) Assignee: FRESENIUS MEDICAL CARE HOLDINGS, INC., Waltham, MA (US)

(21) Appl. No.: 13/647,750

(22) Filed: Oct. 9, 2012

(51) Int. Cl. F16L 3/22; B23P 17/04

(52) U.S. Cl. 248/68.1; 29/428

(57) ABSTRACT

A medical fluid line alignment device that includes a base that is attachable to a support member and a fluid line organizer attachable to the base. The fluid line organizer includes a plurality of access ports that allow fluid lines to be connected to the fluid line organizer. The device further includes a plurality of guides disposed on the base. Each of the guides is aligned with one of the access ports, and each of the guides has a top surface defining a recessed region that is sized and shaped to at least partially receive a fluid line therein.

### TECHNICAL FIELD

This invention relates to medical fluid line alignment devices and related systems and methods.

### BACKGROUND

Many modern medical procedures use tubing sets of varying complexity to withdraw fluid from a patient, or to administer fluid to a patient, or to do both. One example of such a procedure is peritoneal dialysis. In peritoneal dialysis, the patient's blood is cleansed by introducing sterile solution through a tube into the peritoneal cavity of the patient. The peritoneal membrane acts as a partially permeable membrane across which dissolved substances such as electrolytes, urea, and other molecules are exchanged from the blood.

The solution, or dialysate, is pumped into the peritoneal cavity via a sterile tube, left there for a period of time to absorb waste products diffused from the patient's blood across the peritoneal membrane, and is then drained out through the same tube, or a second tube, and discarded. Extracorporeal components including a peritoneal tubing set and possibly a pump are typically used to transport the fresh and waste fluids between a patient's abdominal access site and suitable containers.

Peritoneal dialysis is frequently carried out at home by the patient, allowing patients freedom from visiting a dialysis clinic several times a week. If carried out at home, the patient generally prepares the peritoneal dialysis system himself or herself.

### SUMMARY

In one aspect of the invention, a medical fluid line alignment device includes a base that is attachable to a support member, a fluid line organizer attachable to the base, and a plurality of guides disposed on the base. The fluid line organizer includes a plurality of access ports that allow fluid lines to be connected to the fluid line organizer. Each of the guides is aligned with one of the access ports, and each of the guides has a top surface defining a recessed region that is sized and shaped to at least partially receive a fluid line therein.

In another aspect of the invention, a medical fluid line alignment system includes a support member, a base attached to the support member, a fluid line organizer attached to the base, and a plurality of guides disposed on the base. The fluid line organizer includes a plurality of access ports that allow fluid lines to be connected to the fluid line organizer. Each of the guides is aligned with one of the access ports, and each of the guides has a top surface defining a recessed region that is sized and shaped to at least partially receive a fluid line therein.

In a further aspect of the invention, a method for aligning fluid lines includes disposing a fluid line in a recessed region of a guide aligned with an access port, sliding the fluid line along the guide and into engagement with the access port, and connecting the fluid line to the access port.

Implementations can include one or more of the following features.

In some implementations, the base is configured to rotate relative to the support member when the base is attached to the support member.

In certain implementations, the base is configured to rotate relative to a user positioned in front of the medical fluid line alignment device such that that a user can maintain substantially the same body position when manipulating the device.

In some implementations, a first end of each of the guides is aligned with the front edge of the base.

In certain implementations, the first end of each of the guides is flush with the front edge of the base.

In some implementations, a second end of each of the guides is aligned with access ports on the fluid line organizer.

In certain implementations, the second end of each of the guides is located 0.5 inch to 1.5 inches away from its associated access port on the fluid line organizer.

In some implementations, the guides guide motion of fluid lines towards the access ports.

In certain implementations, the recessed region of the upper surface limits side to side and downward motion.

In some implementations, the recessed region of the upper surface has a radius of curvature of 0.25 to 1.5 inches.

In certain implementations, the support member includes a table.

In some implementations, the table is portable.

In certain implementations, the support member includes a portable pole.

In some implementations, the fluid line organizer is configured to attach to an adaptor.

In certain implementations, the fluid line organizer at least partially defines a slot configured to receive a portion of the adaptor.

In some implementations, the slot is defined between the fluid line organizer and a riser extending from the base.

In certain implementations, the adaptor suspends the fluid line organizer from the portable pole.

In some implementations, the base is sized to facilitate attachment of the adaptor to the fluid line organizer.

In certain implementations, the base has a length of 8.5 inches to 9.5 inches.

In some implementations, an end of the fluid line organizer is flush with an end of the base.

In certain implementations, a first end of each of the guides is flush with a front edge of the base.

In some implementations, a second end of each of the guides is aligned with access ports of the fluid line organizer.

In certain implementations, the second end of each of the guides is located 0.5 inch to 1.5 inches away from its associated access port on the fluid line organizer.

In some implementations, the support member is a portable pole.

In certain implementations, the system further includes an adaptor having a portion that is received in a slot at least partially defined by the fluid line organizer, and the adaptor is secured to the portable pole.

In some implementations, the slot is defined between the fluid line organizer and a riser extending from the base.

In certain implementations, the method further includes connecting a fluid line alignment device to a portable pole prior to disposing the fluid line in the recessed region of the guide, and the guide is attached to a base of a fluid line alignment device and the access port is attached to a fluid line organizer that is connected to the base.

Implementations can include one or more of the following advantages.

Medical fluid line alignment devices (e.g., dialysis solution line alignment devices) described herein can advantageously simplify and ease the difficulty of attaching fluid lines to fluid line connectors of a medical device (e.g., a peritoneal dialysis solution line organizer) in a manner to achieve a sterile connection. This advantage can be realized without requiring full sight or substantial manual dexterity in order to manipulate the fluid lines relative to their attachment positions. As a result, the medical fluid alignment devices described herein can allow patients that lack full sight and/or dexterity to successfully connect fluid lines to fluid line connectors in a sterile manner without the assistance of an aid in many cases.

In some implementations the alignment assembly rotates relative to the patient's forward facing direction. Due to this ability to rotate, the patient can make the same forward/backward and screwing/unscrewing movements without changing his or her body position to attach and detach dialysis solution lines from multiple different fluid line connectors arranged along a medical device. For a patient with reduced dexterity or vision, this is advantageous because the patient can maintain the same body positioning and motion, rather than attempting different movements and possibly losing spatial orientation relative to the attachment points. As a result, less time is needed to carry out the attachments, and the possibility for error, such as attaching a fluid line to the wrong port, can be reduced.

The details of one or more embodiments of the invention are set forth in the accompanying drawings and the description below. Other aspects, features, and advantages of the invention will be apparent from the description and drawings, and from the claims.

### DESCRIPTION OF DRAWINGS

FIG. 1 is a perspective view of a dialysis solution line alignment system that includes a fluid line organizer attached to an alignment plate, which is rotatably connected to a table.

FIG. 2 is a perspective view of the fluid line organizer and alignment plate shown decoupled from the table of the dialysis solution line alignment system of FIG. 1.

FIG. 3 is a perspective view of the alignment plate of the dialysis solution line alignment system of FIG. 1.

FIG. 4 is a perspective view of a dialysis solution line alignment system that includes a fluid line organizer attached to an alignment plate and an IV pole connector which can attach the fluid line organizer and alignment plate to an IV pole.

FIG. 5 is a side, perspective view of the dialysis solution line alignment device system of FIG. 4 attached to an IV pole via the IV pole connector.

### DETAILED DESCRIPTION

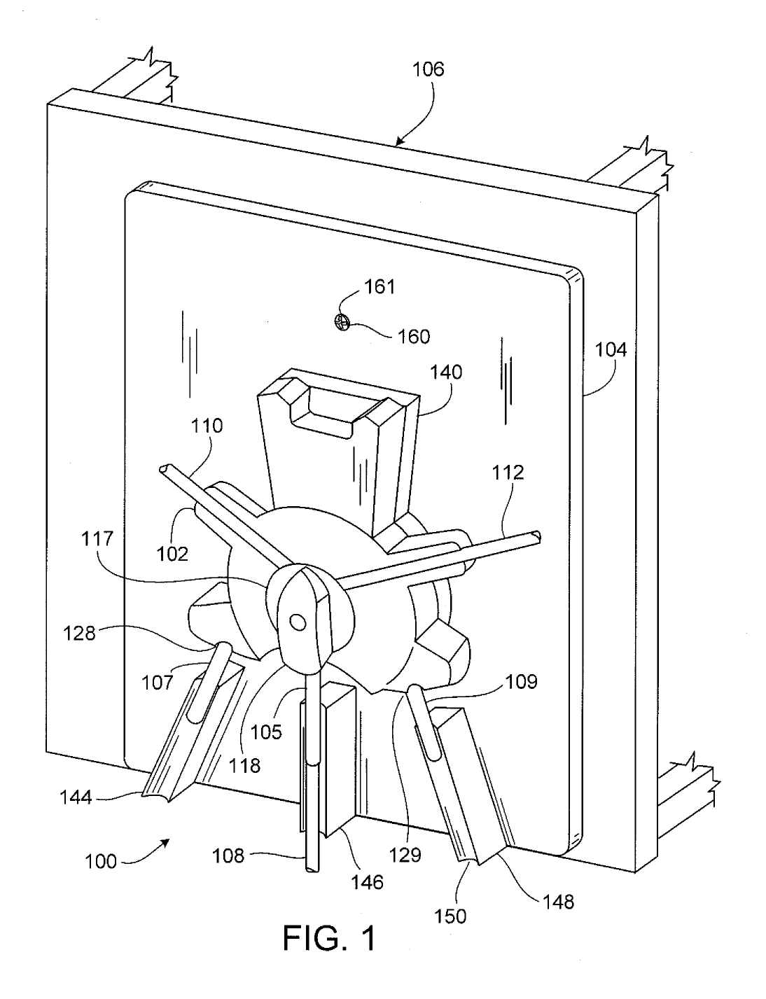

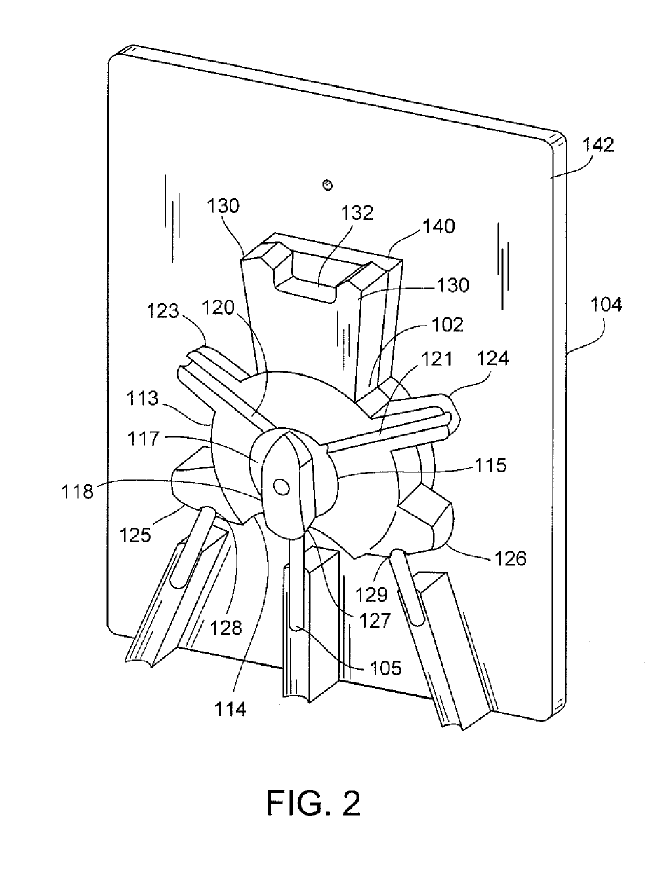

Referring to FIGS. 1 and 2, a dialysis solution line alignment system 100 includes a fluid line organizer 102, a generally flat alignment assembly 104, and a table 106. The fluid line organizer 102 attaches to the top surface of the alignment assembly 104, which in turn is rotatably connected to the top of the table 106.

The fluid line organizer 102 is used to simplify the fluid connections between a patient's abdominal cavity and dialysate supply and waste containers required during peritoneal dialysis. When seated in fluid line organizer 102, a removable, rotatable disc 117 can be rotated into various positions to open and close fluid paths that allow the abdominal cavity and fluid containers to be fluidly connected and disconnected. To enable this, the disc 117 contains several holes that allow fluid lines 110, 112 and patient line (e.g., patient catheter) 108 to be fluidly connected to the interior of the disc 117.

Fluid lines 110, 112 are permanently attached to disc 117 at one end and can be attached at their other end to dialysate supply and waste containers at the time of treatment. The patient fluid line 108 is connected to the patient's peritoneal cavity at one end and can be connected to the disc 117 via a permanently attached fluid line attachment 105 at the other end. With the disc 117 (including attached fluid lines 110, 112 and fluid line attachment 105) seated in fluid line organizer 102 and the patient fluid line 108 attached to the disc 117, the patient can easily rotate the disc 117 into positions that allow spent dialysate to drain from his or her abdominal cavity into a waste container, and fresh dialysate to flow from a supply container and fill the abdominal cavity.

Additionally, the fluid line organizer 102 contains two ports 128, 129 in which removable fluid line caps 107, 109 can be placed safely and sterilely during treatment.

Referring to FIG. 2, the fluid line organizer 102 has a generally cylindrical main body 113. One side of the main body 113 includes a concavity 114, which defines a forward direction when orienting the fluid line organizer 102 and also defines an overall crescent shape of the main body 113. When viewed from the front, the forward-facing wall of the main body 113 contains a notch (not shown) that extends from the top surface of the fluid line organizer 102 to approximately half way down the front face of the concavity 114. The notch on the forward-facing wall of the main body 113 permits the fluid line attachment 105 to fluidly connect the patient fluid line 108 to the interior of the disc 117.

The central region of the main body 113 has a generally cylindrical center cavity 115. The top surface of the main body 113 also includes two side channels 120, 121 that extend radially from the center cavity 115. The cylindrical side channels 120, 121 extend from the sides of and connect to the curved sides of the cylindrical center cavity 115, such that the cylindrical side channels 120, 121 are connected to the cylindrical center cavity 115.

The cylindrical center cavity 115 is configured to receive the rotatable disc 117 which includes a graspable knob 118. The rotatable disc 117 includes an access port 127 on its curved face that can allow the interior of the rotatable disc 117 to be fluidly connected to patient fluid line 108. When the alignment assembly is assembled, the rotatable disc 117 is seated in the cylindrical center cavity 115, and the graspable knob 118 extends upward from the surface of the rotatable disc 117. The graspable knob 118 can be grasped by the patient and used to rotate the disc 117 relative to the cylindrical main body 113.

Attached to the sides of the fluid line organizer body 113 are upper protrusions 123, 124, and lower protrusions 125, 126. The upper protrusions 123, 124 are located where the cylindrical side channels 120, 121 intersect the sides of the fluid line organizer body 113. The upper protrusions 123, 124 include recessed regions that act as extensions of the side channels 120, 121 beyond the fluid line organizer body 113. The side channels 120, 121 are configured to receive and retain the fluid lines 110, 112. The fluid lines 120, 121 can be formed of medical grade tubing such as is typically used during peritoneal dialysis.

The lower protrusions 125, 126 on the fluid line organizer body 113 are located on either side of and adjacent to the concavity 114. The lower protrusions 125, 126 each have an access port 128, 129 located on the forward-facing surface of the protrusion. The access ports 128, 129 (as well as the access port 127 on the disc 117) are typically internally threaded as luer locks and mate with fluid line attachment 105 and fluid line caps 107, 109. The fluid line attachment 105 and the fluid line caps 107, 109 can have multiple threads to connect to the access ports 128, 129 on one side and to fluid lines (e.g., patient fluid line 108) or attachment covers on the opposite side.

Attached to the side of the fluid line organizer body 113 directly opposite the concavity 114 is an adaptor extension 130, which contains a slot 132 configured to receive a broad attachment piece, which is described below.

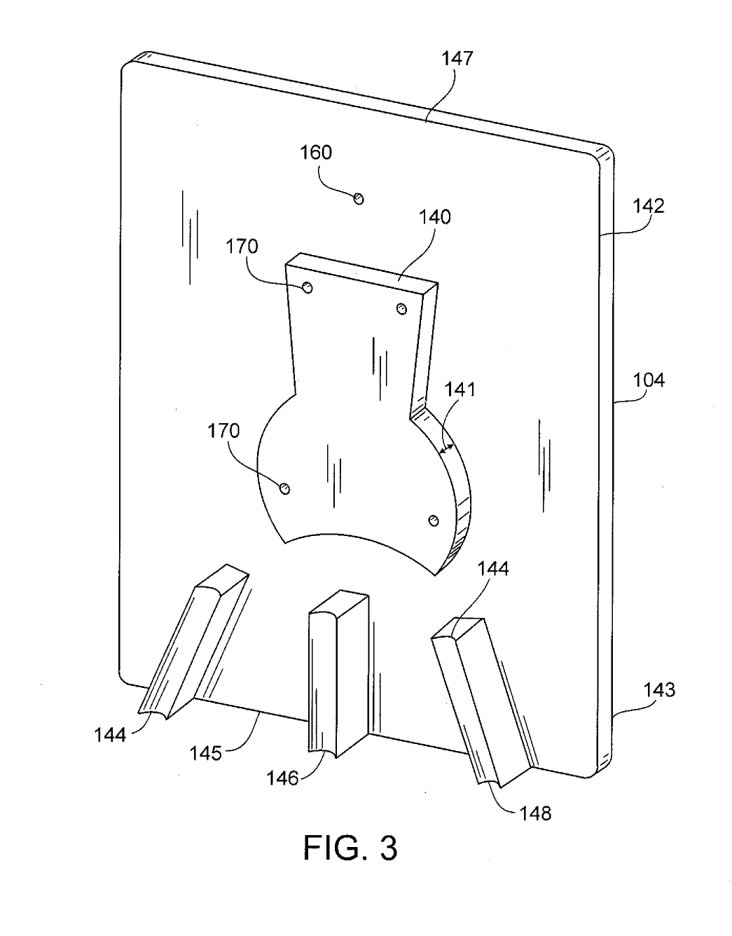

As shown in FIG. 2, the alignment plate 104 includes a broad, generally flat base 143. The base 143 is sized to be easily moved and manipulated. In some implementations, the base 143 is approximately 10″ in width, 12″ in length and 1.28″ thick. The fluid line organizer 102 is attached to a generally flat organizer riser 140 that extends upwards from the base 143. The fluid line organizer riser 140 is located approximately in the center of the top surface 142 of the base 143 of alignment assembly 104. As can be seen in FIG. 3, the overall shape of organizer riser 140 is similar to the outline of the fluid line organizer body 113 and adaptor extension 130. The fluid line organizer riser 140 has a height 141 such that when attached, the fluid line organizer 102 is located a distance equal to height 141 above the top surface 142 of the alignment assembly. Height 141 is selected to allow room for a patient's fingers to manipulate attachments to organizer 102. Height 141 is typically approximately 0.5 inch.

Located on the top surface 142 of the base 143 are three guides 144, 146, 148. The guides are arranged on the base 143 such that each guide touches (e.g., is flush with) the front edge 145 of the base. The middle guide 146 points toward the center of fluid line organizer 102 when the fluid line organizer 102 is attached to the fluid line organizer riser 140. More particularly, the middle guide 146 points toward the access port 127 located in the disc 117 of the fluid line organizer 102. The two outside guides 144, 148 are angled such that the guides point towards the access ports 128, 129 located on the lower protrusions 125,126 on either side of the fluid line organizer body 113. The guides are arranged such that a patient can easily and tactilely locate and follow a path towards access ports 127, 128, 129.

The three guides 144, 146, 148 have grooves 150 on their upper surfaces. The grooves 150 are sized to receive fluid lines, such as tubing typically used during peritoneal dialysis and typically have a radius of curvature of approximately 0.5 inches. As a patient moves an attachment device (such as a fluid line) in a forward motion towards one of access ports 127, 128, 129, the grooves 150 limit the motion of the attachment device, restricting its side to side as well as downward motion.

The guides 144, 146, 148 are sized so that they can be easily located by touch and grasped. Their heights and lengths are also chosen to allow room between the guides 144, 146, 148 and the fluid line organizer 102 for threading and unthreading connections. For example, the heights from the base to the lowest points of the radiused grooves of the outside guides 144, 148 can be approximately 0.69 inch and the overall heights of the outside guides 144, 148 can be approximately 0.78 inch, while the height from the base to the lowest point of the radiused groove of the middle guide 146 can be approximately 0.88 inch and the overall height of the middle guide 146 can be approximately 0.97 inch.

The front edge 145 of the base 143 provides a landmark so the guides 144, 146, 148 (which are aligned at one end with the front edge 145) can be easily found. All three guides extend from the front edge 145 of the base 143 towards the fluid line organizer 102 to allow the patient to slide a fluid line along the upper surface of the guide. For example, the outside guides 144, 148 can be approximately 4.25 long and the middle guide 146 can be approximately 3.97 long. Alternatively, the guides 144, 146, 148 can have other lengths. Typically, these lengths range from 2.0 inches to 7.0 inches.

The guides 144, 146, 148 end just short of the fluid line organizer 102, providing a gap between the guides 144, 146, 148 and the fluid line organizer 102 that is sized for a patient to insert his or her fingers in order to easily thread and unthread connections. This gap is typically approximately 0.65 inches between the fluid line organizer and the end of the middle guide 146, and approximately 0.87 inches between the fluid line organizer and the ends of outside guides 144, 148. However, any appropriate length of gap can be chosen that allows the patient to insert his or her fingers (e.g., between 0.5 and 1.5 inches).

A hole 160 is located approximately 1.5 inches from the back edge 147 on the centerline of the base 143. A bolt 161 can attach the alignment assembly 104 to a table 106 via the hole 160 (as shown in FIG. 1). The hole 160 and the bolt 161 are sized such that the alignment assembly 104 can rotate freely about an axis of rotation defined by the length of the bolt 161. Alternatively, the bolt 161 may be a screw, a dowel, or other attachment device.

Enabling the alignment assembly 104 and the fluid line organizer 102 to rotate relative to a table 106 provides the patient the ability to change the orientation of the alignment assembly 104 and the fluid line organizer 102 relative to the table 106 as well as to the patient's body. When connecting or disconnecting various attachments to or from the fluid line organizer 102, the patient can rotate the attached organizer 102 and the alignment assembly 104 to a position that is most comfortable for the patient. This rotation can be towards a position that eases use for either a left handed or right handed person. In addition, this rotation can permit small adjustment angles during use, allowing the patient to employ the same combination of hand and arm motions multiple times, rather than changing his or her body positioning to access each connection access port 127, 128, 129. This ability to rotate is particularly advantageous to patients who have impaired mobility, as the alignment assembly 104 can be moved into positions that are within the patient's range of motion. The ability to rotate the fluid line organizer 102 and the alignment assembly 104 relative to the patient is also particularly advantageous to patients who are visually impaired. Repeating the same sequence of moves allows a visually impaired person to maintain spatial orientation, rather than attempting to successfully connect two objects with different motions and without visual cues.

As seen in FIG. 3, the base 143 and the fluid line organizer riser 140 each form multiple through holes 170. The through holes 170 allow the alignment assembly 104 to be screwed to the back of organizer 102. Suitable screws can be inserted through the base 143, the fluid line organizer riser 140, and into the back face of organizer 102. In some implementations, the through holes 170 are threaded. Aligned holes in the organizer and organizer riser 140 can alternatively or additionally be threaded.

Typically, the alignment plate 104 is assembled from five individual parts: the three guides, the assembly base 143 and the fluid line organizer riser 140. All pieces are formed separately and are screwed and/or glued together.

The base 143, the fluid line organizer riser 140, and the guides 144, 146, 148 are typically injection molded components preferably made of a biocompatible high-impact thermoplastic material. Examples of biocompatible high-impact thermoplastic materials include polypropylene, polyvinyl chloride, polycarbonate, polysulfone, and other medical grade plastic materials.

The dialysis solution line alignment system 100 including alignment assembly 104 and the fluid line organizer 102 when assembled is lightweight for easy manipulation. Typically, the dialysis solution line alignment system 100 weighs less than 2 lbs. (e.g., approximately 1.96 lb.).

The dialysis solution line alignment system 100 can be used by a patient to perform peritoneal dialysis. To perform the peritoneal dialysis treatment, the patient fluid line 108 is connected to the abdominal cavity of the patient. Any of various known methods can be used to connect the patient fluid line 108 to the subject. For example, the patient fluid line 108 can be fluidly connected to a port or catheter implanted within the abdominal cavity of the patient.

Prior to a treatment cycle, the alignment assembly 104 is fixed to the table 106. The base 143 of the alignment assembly 104 is attached via a bolt 161 through the through hole 160. Once attached, the base 143 is free to rotate about the bolt 161. This set up step may be performed before each treatment cycle, or may be performed once and left in place for multiple treatment cycles.

To begin treatment, the disc 117 is inserted into the cylindrical center cavity 115 in the center of the main body 113. Graspable knob 118 on the top surface of the fluid line organizer body 113 provides a large landmark indicating which side of the fluid line organizer body 113 is up. Fluid lines 110, 112, and fluid line attachment 105 that are connected to the disc are inserted into the cylindrical side channels 120, 121, and front notch respectively. The connected fluid lines 110, 112, and the fluid line attachment 105 can be fit into their respective channels and notch by feel, without the aid of visual cues. When properly inserted, the disc 117 is in a first position that fluidly connects the fluid line attachment 105 to the first fluid line 110.

The first of a series of screw connections is then made to the fluid line organizer 102. The patient rotates the alignment assembly and attached organizer 102 to an angle at which he can comfortably touch guide 144. The patient then locates groove 150 on top of the guide 144, and, holding a sterile fluid line cap 107, follows the groove until the fluid line cap 107 is fitted into the access port 128. The patient then screws the fluid line cap 107 into place.

The patient may also optionally rotate the alignment assembly 104 slightly into a position that makes manipulation of attachments along the central guide more comfortable. This slight rotation step is optional for any of the screwing/unscrewing connection steps. The patient locates the groove 150 on the guide 148, and slides the patient fluid line 108 into a mating position with the access port 129. At its proximal end the patient fluid line 108 is attached to the patient's abdominal cavity, and at its distal end it is attached to a screw-fastened cap that prevents contamination of the patient fluid line 108. Once the patient fluid line 108 is fitted into place, the patient screws the cap of the fluid line into access port 129.

The patient then locates the central guide 146, and its guiding groove 150. The patient may also optionally rotate the alignment assembly 104 slightly into a position that makes manipulation of attachments along the central guide more comfortable. The patient then follows the central guide 146 to the central fluid line attachment 105, which is located in its attached position in disc 117. The patient unscrews a safety cap from the fluid attachment 105.

Next, the patient again locates the third guide 148 and follows the patient fluid line 108 and the guide 148 to the access port 129, where he unscrews the fluid line from its cap, which remains in the access port 129. Using the central guide 146, he locates the fluid attachment 105 and screws the patient tube 108 into place in fluid attachment 105 seated in access port 127.

The patient has now attached the patient fluid line 108 to the fluid line organizer 102 such that spent dialysate may be drained from the abdominal cavity. A suitable valve or clamp located on the patient fluid line 108 can be released to allow the spent fluid to drain from the abdominal cavity, and in turn through the patient fluid line 108, the disc 117, and fluid line 110 into an appropriate waste container. The fluid drains under the force of gravity.

Once the drain is complete, the patient turns the graspable knob 118 to a second position. Once in the second position a fill bag of new dialysate attached to fluid line 112 becomes fluidly connected through the disc 117 to the fluid line 110. New dialysate drains (under gravimetric forces) through the disc 117 and into the waste container via fluid line 110.

After approximately five seconds of flow, the patient turns the graspable knob 118 to a third position. In the third position, the new dialysate and fluid line 112 become fluidly connected to the patient fluid line 108. New dialysate drains through the fluid line 112, the disc 117, and the patient fluid line 108 to fill the abdominal cavity.

When the fill is complete, the patient turns graspable knob 118 to a fourth position that fluidly disconnects the patient fluid line 108 from the disc 117 and the fluid line organizer 102.

The patient locates the first guide 144, and locates the fluid line cap 107 placed there earlier. The patient unscrews the safety cap at the proximal end of the fluid line cap 107.

The patient then locates the second guide 146, and follows the guide to encounter the attachment of patient fluid line 108. The patient fluid line 108 is unscrewed from the fluid line attachment 105.

The patient once again locates the first guide 144, and slides the patient fluid line 108 along the guide until it connects with fluid line cap 107. The patient screws the patient fluid line into the fluid line cap 107, and then unscrews the fluid line cap 107 from the fluid line organizer 102. The treatment cycle is now complete.

While various embodiments have been described above, other embodiments are possible. For example, while a table 106 has been described, other types of support members could be used. The support member could be provided by the manufacturer or could be a support member provided by the patient. The support member can be any fixed object such as a desk or shelf. To allow mobility for the patient, the support member may also be a mobile object, such as a cart, stand, or tray.

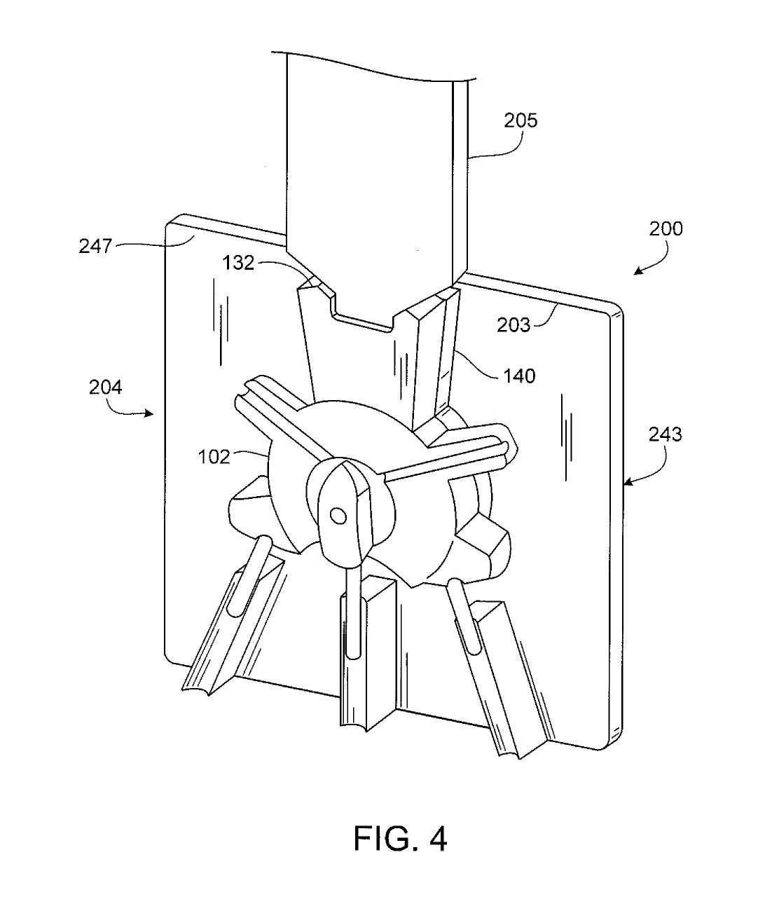

While the alignment assembly 104 has generally been described as being attachable to a flat table, other configurations are possible. For example, referring to FIG. 4, a dialysis solution line alignment system 200 includes slot a 132 which is configured to receive IV pole adaptor 205. The slot 132 is formed between the fluid line organizer 102 and the riser 140. IV pole adaptor 205 is configured to attach the dialysis solution line alignment system 200 to a non-flat surface such as an intravenous (IV) pole 206.

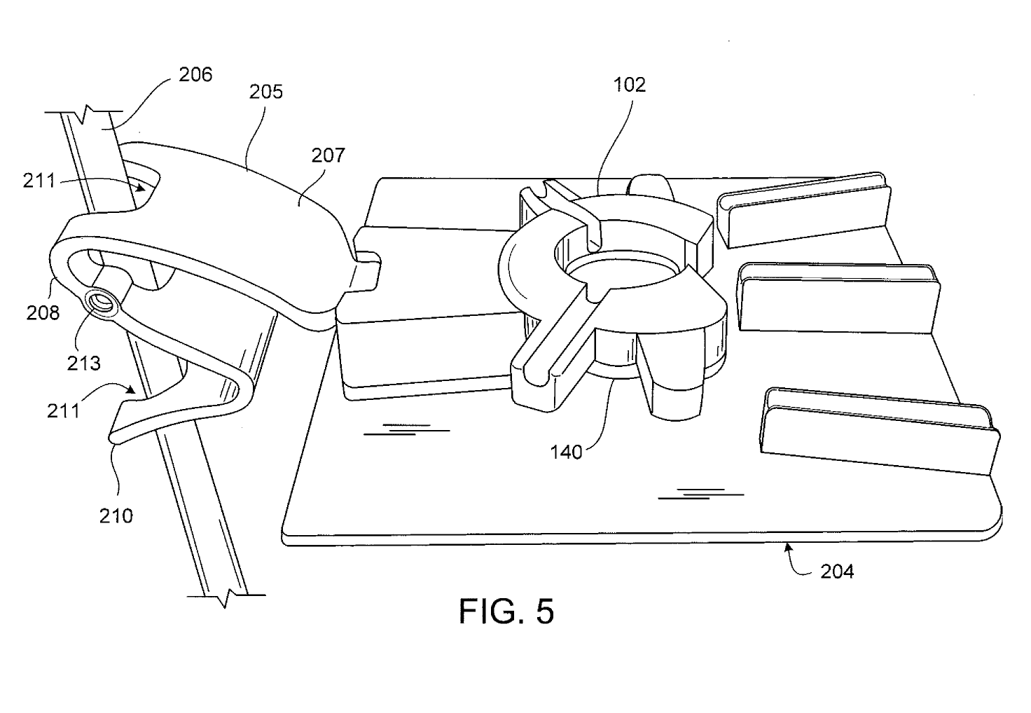

FIG. 5 shows an embodiment in which the dialysis solution line alignment system 200 is suspended from an IV pole. When viewed from the side IV pole adaptor 205 has an “S” outline, where the top protrusion 207 of the “S” inserts into slot 132 on the fluid line organizer 132. The “spine” including the far end of top protrusion 207, the slanted protrusion 208 and bottom protrusion 210 of IV pole adaptor 205 contains slots 211 that fit around IV pole 206. IV pole adaptor 205 is configured to fit around standard IV poles, which are typically one inch in diameter.

Both sides of slanted protrusion 208 have threaded screw holes 213. Long screws can be threaded through the threaded screw holes 213 and to apply radial force to the IV pole 206. By tightening the screws, IV pole adaptor 205 can be attached the IV pole 206. When slightly loosened, the screws may permit IV pole adaptor 205 to rotate around the IV pole 206 into the various positions desired by the patient during use of the dialysis solution line alignment system 200. When fully loosened, the height of IV pole adaptor 205 can be adjusted, or it can be removed from the IV pole 206.

In a suspended configuration such as shown in FIG. 5, it is desirable to bring the center of mass of the assembled organizer 102 and alignment assembly 204 as close as possible to IV pole. This proximity minimizes induced vibrations due to movement of the IV pole or to accidental striking or mishandling of the dialysis solution line alignment system 200. To reduce the distance between the center of mass of the combined organizer 102 and the alignment assembly 204, the distance 203 from the fluid line organizer and riser 140 to the back edge 247 of the alignment assembly is shortened to 8.5 to 9.5 inches. This shortened base 243 also has the advantage of decreasing the mass of the suspended dialysis solution line alignment system 200.

In some implementations, other devices or techniques are used to connect the guides 144, 146, 148 to the base 143. For example, alternatively or in addition to glue and/or screws, other fasteners (e.g., bolts, rivets, or other fasteners) can be used.

While the alignment device 104 has been described as having components that are formed separately and then coupled together, the alignment device can alternatively be formed as one integral piece. For example, injection molding or die casting techniques can be used to form a one-piece alignment device.

While various components of the alignment assembly 104 have been described as being formed of medical grade plastics, other types of materials can be used. For example, alignment assembly 104 can be made of stainless steel, aluminum, or other material that can be cleaned and/or sterilized before use. The guides 144, 146, 148, the base 143, and the fluid line organizer riser 140 may not necessarily be solid pieces. In some cases, for example, they are hollow. Hollow pieces can be formed by extrusion, rolling, bending, or other method known in the art.

While the dialysis solution line alignment system has been described as a component for a peritoneal dialysis system, similar line alignment system can alternatively or additionally be used with other types of body fluid treatment systems where attachment of fluid lines to a device is required. Examples of other types of blood treatment systems include

Use of gravimetric forces to generate fluid flow has been described; however appropriate pumps or rollers could be used to push fluid through the fluid lines, and into and out of the abdominal cavity.

A number of embodiments of the invention have been described. Nevertheless, it will be understood that various modifications may be made without departing from the spirit and scope of the invention. Accordingly, other embodiments are within the scope of the following claims.

1. A medical fluid line alignment device comprising:
a base that is attachable via an adaptor to a support member, the support member comprising a portable pole;
a fluid line organizer attachable to the base, the fluid line organizer comprising a plurality of access ports that allow fluid lines to be connected to the fluid line organizer; and
a plurality of guides disposed on the base, wherein each of the guides is aligned with one of the access ports, and each of the guides has a top surface defining a recessed region that is sized and shaped to at least partially receive a fluid line therein.

2. The medical fluid line alignment device of claim 1, wherein the base is configured to rotate relative to the support member when the base is attached to the support member.

3. The medical fluid line alignment device of claim 2, wherein the base is configured to rotate relative to a user positioned in front of the medical fluid line alignment device such that that a user can maintain substantially the same body position when manipulating the device.

4. The medical fluid line alignment device of claim 1, wherein a first end of each of the guides is aligned with the front edge of the base.

5. The medical fluid line alignment device of claim 4, wherein the first end of each of the guides is flush with the front edge of the base.

6. The medical fluid line alignment device of claim 1, wherein a second end of each of the guides is aligned with access ports on the fluid line organizer.

7. The medical fluid line alignment device of claim 6, wherein the second end of each of the guides is located 0.5 inch to 1.5 inches away from its associated access port on the fluid line organizer.

8. The medical fluid line alignment device of claim 1, wherein the guides guide motion of fluid lines towards the access ports.

9. The medical fluid line alignment device of claim 1, wherein the recessed region of the upper surface limits side to side and downward motion.

10. The medical fluid line alignment device of claim 1, wherein the recessed region of the upper surface has a radius of curvature of 0.25 inch to 1.5 inches.

11-14. (canceled)

15. The medical fluid line alignment device of claim 1, wherein the fluid line organizer at least partially defines a slot configured to receive a portion of the adaptor.

16. The medical fluid line alignment device of claim 15, wherein the slot is defined between the fluid line organizer and a riser extending from the base.

17. The medical fluid line alignment device of claim 1, wherein the adaptor suspends the fluid line organizer from the portable pole.

18. The medical fluid line alignment device of claim 1, wherein the base is sized to facilitate attachment of the adaptor to the fluid line organizer.

19. The medical fluid line alignment device of claim 18, wherein the base has a length of 8.5 inches to 9.5 inches.

20. The medical fluid line alignment device of claim 18, wherein an end of the fluid line organizer is flush with an end of the base.

21. A medical fluid line alignment system comprising:
a support member comprising a portable pole;
a base attached to the support member via an adaptor;
a fluid line organizer attached to the base, the fluid line organizer comprising a plurality of access ports that allow fluid lines to be connected to the fluid line organizer; and
a plurality of guides disposed on the base, wherein each of the guides is aligned with one of the access ports, and each of the guides has a top surface defining a recessed region that is sized and shaped to at least partially receive a fluid line therein.

22. (canceled)

23. The medical fluid line alignment system of claim 21, wherein the adaptor has a portion that is received in a slot at least partially defined by the fluid line organizer, the adaptor being secured to the portable pole.

24. The medical fluid line alignment system of claim 23, wherein the slot is defined between the fluid line organizer and a riser extending from the base.

25. A method for aligning fluid lines, the method comprising:
connecting a fluid line alignment device to a portable pole, the fluid line alignment device comprising a base to which a guide is attached;
disposing a fluid line in a recessed region of the guide, the guide being aligned with an access port of a fluid line organizer that is connected to the base;
sliding the fluid line along the guide and into engagement with the access port; and
connecting the fluid line to the access port.

26. (canceled)
